(19) United States
(12) Patent Application Publication
(10) Pub. No.: US 2008/0125682 A1
(43) Pub. Date: May 29, 2008

(54) HEAD FOR MASSAGING AND/OR DISPENSING A PRODUCT AND DEVICE PROVIDED WITH SUCH A HEAD

(75) Inventor: Philippe BONNEYRAT, Herblay (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 11/944,509

(22) Filed: Nov. 23, 2007

Related U.S. Application Data
(60) Provisional application No. 60/868,379, filed on Dec. 4, 2006.

(30) Foreign Application Priority Data
Nov. 23, 2006 (FR) 0655081

(51) Int. Cl. A61H 1/00

(52) U.S. Cl. 601/112

(57) ABSTRACT

A head for applying a product includes a removable member. The member may be used to dispense a product or for massage. The head includes a body that rotates the removable member about an axis of rotation, the removable member being removably coupled to the body; and a part including a movement restriction tab that restricts movement of the removable member along the axis of rotation, the rotation of the removable member being relative to this part. The removable member is configured to be secured to the part independently of its orientation relative to the restriction tab and to be detached from the part by being moved through two movements including a rotational movement and a translational movement. Additionally, the head can be connected to a container and drive mechanism to dispense and massage a product, such as a cosmetic product, into the user's skin.

### CROSS-REFERENCE TO RELATED APPLICATIONS

This document claims priority to French Application Number 06 55081, filed Nov. 23, 2006 and U.S. Provisional Application No. 60/868,379, filed Dec. 4, 2006, the entire content of which are hereby incorporated by reference.

### FIELD OF THE INVENTION

The present invention relates to a head for massaging and/or dispensing a product and to a massage and/or dispensing device comprising a product container provided with such a head.

### BACKGROUND OF THE INVENTION DISCUSSION OF BACKGROUND

Examples of applications of the present invention include dispensing a cosmetic product onto the skin or onto a lock of hair and massaging the product-coated surface in order to enhance the effect of the product. The expression “cosmetic product” is to be understood to mean a product as defined in Council Directive 93/35/EEC of 14 Jun. 1993.

A sample of conventional devices for dispensing a cosmetic product and/or for massaging are listed in the following background discussion.

DE 295 20 230, US Publication 2002/0138926, JP5-137615, WO 2006/090998 and FR 2 829 921 in particular describes examples of devices of the background art. FR 2 829 921 describes a brushing head for an electric toothbrush. This brushing head comprises a brush provided with clip-on heads able to fit with attaching engagement behind an annular rim of a support plate. This support plate can rotate the brush. However, one disadvantage associated with that device is that the clip-on heads do not allow the brush to be removed easily. Indeed, the brush is typically pulled very firmly in order to detach it from the support plate.

DE 295 20 230 describes a brushing head that clips on to a support plate. A disadvantage associated with a head such as the one describes in DE 295 20 230 is that it is difficult to remove the head from the support plate. Such removal indeed carries the risk of damaging the parts that are to be disconnected.

### SUMMARY OF THE INVENTION

One aspect of the present invention provides a head for massaging and/or dispensing a product and a device incorporating such a head that reduces at least one of the aforementioned disadvantages.

Another aspect of the invention provides a head for applying a product. The head includes a removable member. The removable member may be used to dispense a product or for massage. The head includes a body that rotates the removable member about an axis of rotation. The removable member is removably coupled to the body, and a part including a movement restriction tab restricts movement of the removable member along the axis of rotation. The rotation of the removable member is relative to the part. The removable member is configured to be secured to the part independently of its orientation relative to the restriction tab and to be detached from the part by being moved through two movements including a rotational movement and a translational movement. Additionally, the head can be connected to a container and drive mechanism to dispense and massage a product, such as a cosmetic product, into the user's skin or hair.

Another aspect of the present invention provides a massage and/or dispensing head comprising a massage and/or dispensing member that is easy to remove and that can thus easily be changed so that it can be replaced with a new or different member.

One aspect of the invention provides a head for massaging and/or for dispensing a product, such as a cosmetic product. This example includes a massage and/or dispensing member and a body able to rotate the massage and/or dispensing member about an axis of rotation. The massage and/or dispensing member is associated removably with the body. This example includes part movement restriction means for restricting the movement of the massage and/or dispensing member along the axis of rotation. The massage and/or dispensing member is able to rotate relative to this part. The massage and/or dispensing member is typically configured to be secured to the part independently of its orientation relative to the restriction means and to be detached from this part by being moved through a rotational movement and a translational movement.

The massage and/or dispensing member in this example can thus be assembled on the part comprising the restriction means without the need to provide indexing or marking means. This example of the invention can be assembled with a single translational movement of the member relative to this part without requiring accurately angularly aligning the member relative to this part.

Furthermore, the massage and/or dispensing member in this example can be removed without undue force. Such removal can therefore be performed relatively easily with a reduced risk of damaging the parts.

The head may comprise means for preventing the massage and/or dispensing member from rotating relative to the body. For example, the body and the massage and/or dispensing member may comprise mutual-assembly parts of noncircular cross section. In other words, the assembly parts may respectively comprise a flat or may each have a cross section of complementary polygonal shape, such as a square, rectangular, pentagonal, hexagonal, heptagonal, octagonal or some other cross section. In this example, the orientation of the massage and/or dispensing member during mounting on the body is thus dependent on the respective shape of the mutual-assembly parts of the body and of the member.

The massage and/or dispensing member may be rotated continuously with the body. In one example, this member can thus be driven through 360° indefinitely, i.e., continuously in circles. This member may comprise, in succession along the axis of rotation, an assembly part configured to collaborate with the body, a part configured to collaborate with the restriction means, and a portion forming or supporting the massage and/or application member. The member may be produced as a single piece. In one example the massage and/or application surface may be attached to the member. In this case, this surface may be fixed permanently to a support portion, for example, by bonding or by welding.

In one example, the massage and/or dispensing member includes an internal face comprising at least one rib.

The part may comprise an outer casing designed to at least partially envelop the body and the massage and/or dispensing member. This outer casing may circumferentially envelop the massage and/or dispensing member. It may in particular envelop or house the mutual-assembly parts of the body and of the member and a part of the member that collaborates with the restriction means.

The massage and/or dispensing member, in one example, has at least one relief.

The part for mounting the massage and/or dispensing member and the restriction means may both be exclusively provided on one side of an element supporting a massage and/or application surface, and in particular, on a side opposite to this surface.

The restriction means may be configured in such a way as to be moved outwards as the member is mounted on the body. In other words, the massage and/or dispensing member may be configured in such a way as to bear against the restriction means in order to move them outwards as the member is being mounted on the body. In one example, the movement outwards is in a direction perpendicular to the axis of rotation of the member, i.e., in the radial direction. The restriction means may comprise tab with a chamfer to make it easier to move the restriction means outward. A free edge of the massage and/or dispensing member and/or an outward step provided on this member may be able to come to bear against the chamfer in order to move the restriction means outward.

In one example, the restriction means are designed to pivot relative to the part supporting them. This articulation may be at one or more discrete points, or may preferably be axial.

The restriction means may be produced as a single integral component with the part supporting them. In one embodiment, the restriction means are elastically deformable. These restriction means may then comprise a bending point or zone allowing them to be moved and to return to their initial position. A film hinge, a base portion of smaller thickness, the actual shape and configuration of the restriction means, or the material used to produce the restriction means may allow them to deform and, in particular, confer upon them their ability to flex.

As an alternative, the restriction means and the part supporting them may be produced as two separate pieces. In this case, the restriction means may be mounted to pivot on the part supporting them via an attached-axis hinge.

In one example, the restriction means project, for example, in a radial direction, into an opening through which the member is mounted to the head. In this particular example, the part supporting the restriction means comprises a free edging defining an opening through which the massage and/or dispensing member can extend, the restriction means typically project into the opening, but may project in a different direction. The restriction means may comprise at least one tab projecting into this opening. As discussed above, the tab can be shaped in order to have flexibility, or can be hinged. The tab may be made from the same material as the part supporting it, or may be made separately. The opening defined by the free edging can have various shapes, for example, a circular shape.

Thus, the restriction means or tab may initially, before the massage and/or dispensing member is mounted, project into the opening, then be moved outwards, e.g., radially outwards, as the member is being mounted before finally returning to their initial position projecting into the opening once the member has been mounted.

In one example, the massage and/or dispensing member comprises a passage able to be positioned facing the restriction means. The passage comprises a slot provided at the periphery of the massage and/or dispensing member and, in particular, on an external edge of the massage and/or dispensing member.

In another example, the massage and/or dispensing member comprises marking means to make it easier to perform the translational movement of the massage and/or dispensing member relative to the part as it is being removed. The marking means may be a projection or tag that indicates the rotational position of the member relative to the rest of the head.

In one example, the part defines a guide rail, particularly a circumferential one, for the rotational movement of the massage and/or dispensing member. This rail may be delimited by a step, particularly an annular step, extending, for example, from the bowl of the outer casing, forming a bottom stop for the member. The restriction means, in one example, form a top stop for the member in the mounted position.

The massage and/or dispensing member may comprise a duct opening onto an orifice. Furthermore, the body may comprise a channel able to be positioned facing the duct.

The head may comprise means of rotating the massage and/or dispensing member comprising a motor connected to a source of power controlled by a control member. In one embodiment, the motor drives the member through a transmission system. The transmission system typically includes gears.

The body may be push-fitted or press-fitted into the massage and/or dispensing member. Additionally, the massage and/or dispensing member may comprise an internal step limiting the extent to which the body can be push-fitted into the massage and/or dispensing member.

In one embodiment, the massage and/or dispensing member comprises a massage and/or application surface directed obliquely or at right angles to the axis of rotation. This massage and/or application surface may be supported by a plate or disc. This plate may, in cross section taken with respect to the axis of rotation, have a dimension or diameter greater than that of the mutual-assembly parts. The plate may, for example, have a dimension or diameter at least twice that of the mutual-assembly parts.

Another aspect of the present invention is a massage and/or dispensing device comprising a container configured to contain a product. In one example, the product is a cosmetic product, provided with a massage and/or dispensing head.

The container in this example extends along a longitudinal axis. As discussed above, the massage and/or dispensing member may be rotated about an axis of rotation. In one embodiment, the axis of rotation defines an angle with the longitudinal axis of the container. Preferably, the angle is in the range from 90 to 180°, inclusive.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A better understanding of the invention will be gained from reading the following description in conjunction with the accompanying figures. The figures are offered purely as a guide and by way of example, and in no way limit the invention.

FIG. 1 is a schematic profile view, with partial cutaway, of a massage and/or dispensing head according to one example of the invention before a removable member is mounted;

FIG. 2 is a schematic profile view, with partial cutaway, of the massage and/or dispensing head shown in FIG. 1, while the removable member is in the process of being mounted;

FIG. 3 is a schematic profile view, with partial cutaway, of the massage and/or dispensing head shown in FIG. 1, in a first mounted position;

FIG. 4 is a schematic view, with partial cutaway, of a massage and/or dispensing head according to one example of the invention;

FIG. 5 is a schematic profile view, with partial cutaway, of a massage and/or dispensing head according to one example of the invention, in a second mounted position;

FIG. 6 is a schematic view, with partial cutaway, of a massage and/or dispensing head according to one example of the invention in the position of FIG. 5;

FIG. 7 is a schematic view of one example of a massage and/or dispensing member that can be used in the present invention;

FIG. 8 is a schematic profile view, with partial cutaway, of a massage and/or dispensing device according to one example of the invention; and

FIG. 9 is a schematic view from the rear, with partial cutaway, of the device depicted in FIG. 8.

### DETAILED DESCRIPTION OF THE PREFERRED EMBODIMENTS

Referring now to the drawings, like reference numerals are utilized to designate identical or corresponding parts throughout the several views.

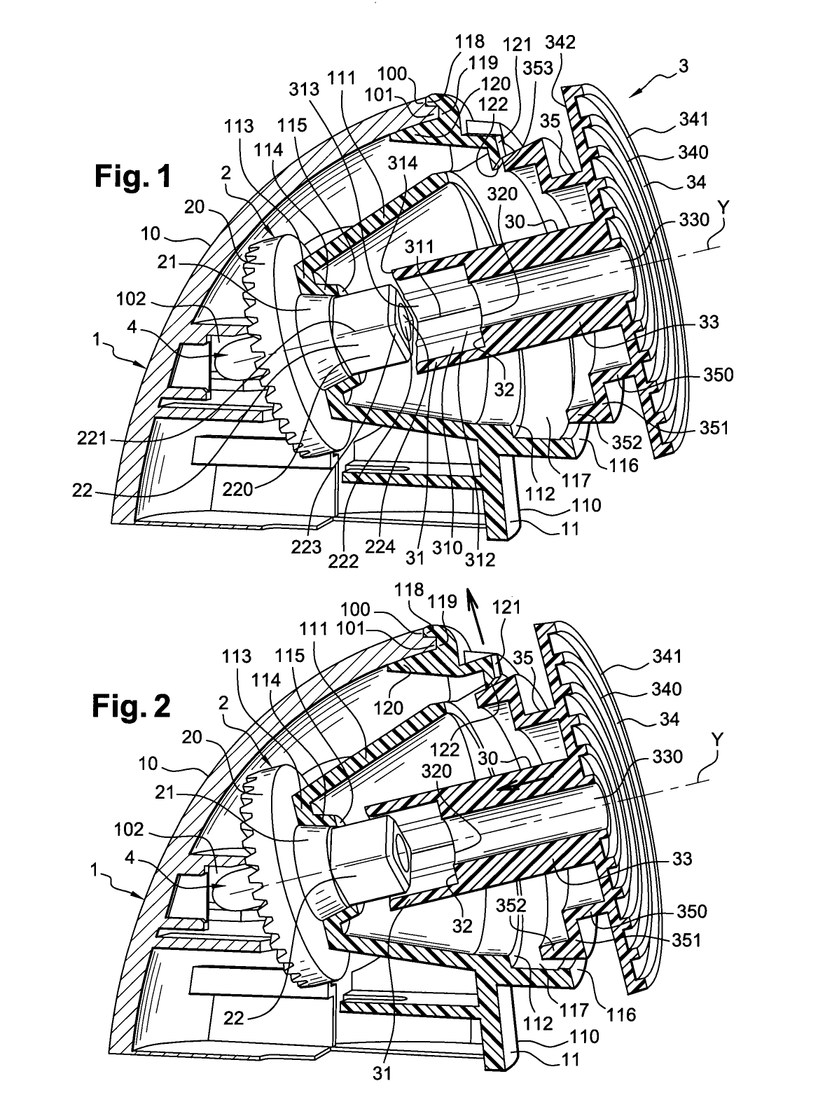

FIG. 1 depicts a massage and/or dispensing head comprising a part 1, a rotational-drive body 2, and a (removable) massage and/or dispensing member 3. The part 1 at least partially envelops the body 2 in such a way as to form an outer casing. This outer casing comprises a first part 10 and a second part 11. The first part 10 comprises a free edge 100 defining a lateral notch. This free edge may have a rib 101. Furthermore, this first part 10 typically includes a housing 102. The second part typically comprises a bib 110 in which a bowl 111 is formed. The bowl 111 has a wall of frustoconical overall configuration and typically includes an external step 112. This bowl may project outwards relative to the bib 110.

In the example shown in FIG. 1, the bowl 111 has two open opposite ends. A first end comprises a radial flange 113 from which there extends a sleeve 114 of frustoconical shape converging towards the inside of the bowl. This sleeve 114 has a free edging 115 defining an opening. This opening may be circular. A second end comprises a free edging 116 defining an opening. This opening may also be of circular shape. The bowl also comprises a wall section 117 extending between the free edging 116 and the external step 112.

In the example shown in FIG. 1, the bib 110 comprises an external periphery 118. The external periphery 118 may be bordered by a groove 119 standing out from which there are one or more projections 120. The bib 110 also typically comprises a tab 121, preferably an elastically deformable one. In the example shown in FIG. 1, this tab 121 is advantageously provided with a chamfer 122. The tab 121 projects into the opening defined by the free edging 116.

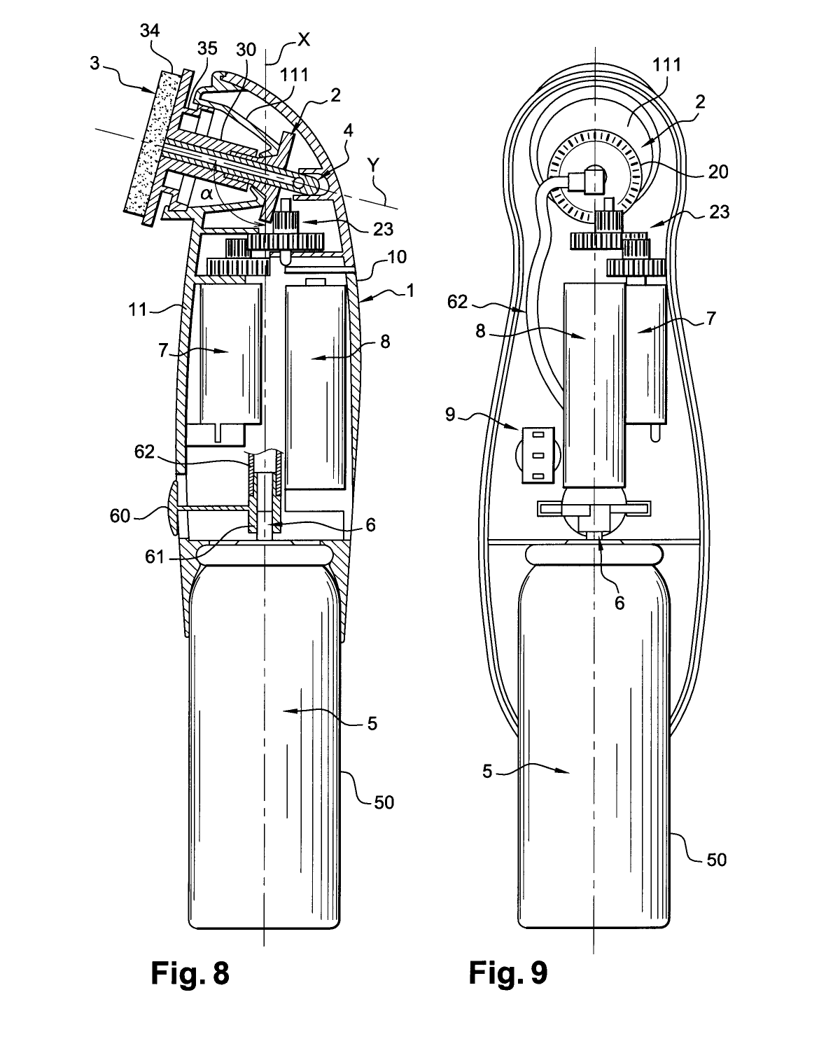

The body 2 may be mounted in the outer casing 1 by means of an axle or hub 4. This axle typically supports the body 2. As can be seen in FIG. 8, this axle 4 may internally define a passageway. An axle such as shown in FIG. 8 may then comprise an aperture for the insertion of a dispensing tube 62 as shown in FIGS. 8 and 9.

In the example in FIG. 1, the body 2 may include a crown gear 20 from which there extends a ring 21 and a support piece 22. The body 2 may further include an external face 220 and an internal face 222. The internal face 220 shown in FIG. 1 defines a channel opening onto an orifice 224. This channel may have a circular cylindrical configuration. A channel such as the one shown in FIG. 1 may be used for mounting onto the axle 4.

In the example shown in FIG. 1, the support piece 22 comprises a transverse part 223 provided with the orifice 224. As further shown in FIG. 1, the transverse part can have a chamfered edge. The support piece 22 externally defines an appendage of substantially cubic or parallelepiped shape. The external face 220 thus in this region can have a cross section of substantially square or rectangular shape. This external face 220 may have angular edges each having a rounded profile 221. This body 2 may, for example, be made of polyoxymethylene, of polyamide or of a metallic material.

The member 3 is preferably a dispensing member through which a product, for example, a cosmetic product, is dispensed. As an alternative or in addition, the member 3 can be configured to massage an area of the body onto which the product has been dispensed. While they may be made of the same material, the member 3 is preferably made of a different material than the body 2. For example, the member 3 may be made of a low-density or high-density polyethylene, of polypropylene, of polyamide, or of polyvinylchloride. The material of which the member 3 is made is preferably compatible with the product that is to be dispensed.

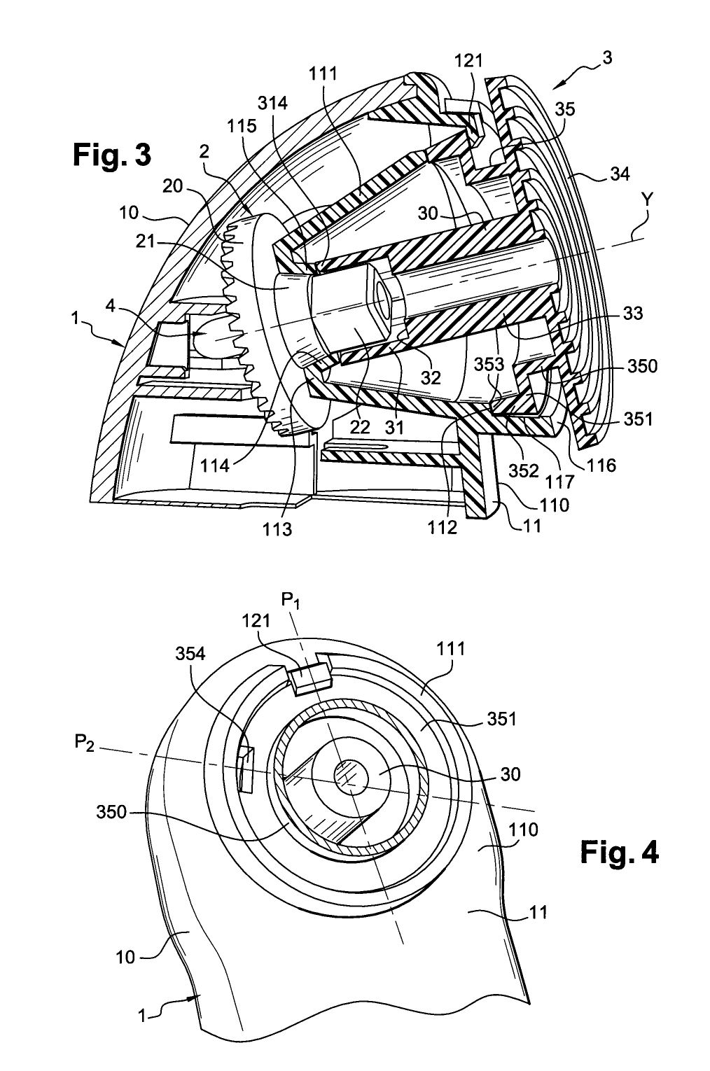

In the example shown in FIG. 3, the member 3 comprises a sleeve tube 30 including a mounting part 31 and a product-expelling part 33. The mounting part 31 may be demarcated from the product-expelling part 33 by an internal step 32. The mounting part 31 comprises an internal face 310 defining a housing of substantially cubic or parallelepiped shape. In the internal face 310 (shown in FIG. 1) thus has a cross section of substantially square or rectangular shape. This housing has four lateral faces together defining two opposed openings 313 and 320 respectively. The opening 320 is, for example, defined by the internal step 32. The opening 313 is defined by a free edge 314 of the mounting part 31.

The internal face 310 may comprise at least one rib 312. The rib or ribs 312 may have a substantially hemispherical cross section. This internal face 310 may also include junctions or intersections 311 with rounded profiles, particularly profiles in the form of a quarter of a circle.

The opening 320 forms the mouth of the duct 33. At the end opposite to the opening 320, the duct 33 opens into an outlet orifice 330. This duct 33 may have a circular cylindrical overall configuration.

The member 3 may also comprise an application element 34. In the example shown in FIG. 1, the application element 34 is in the form of a disc comprising a first face 340 and a second face 342. However, non-circular shapes can also be used.

The first face 340 may be configured to come into contact with an area of the body. Thus, in the example shown in FIG. 1, the first face forms a massage and/or application surface. This first face may be flat. Alternatively, the first face may have at least one relief 341. A relief such as relief 341 may, for example, include a number of annular runs of beading running concentrically. In other words, a relief such as the one shown in FIG. 1 can be formed of one or more elements of convex shape.

In the embodiment shown in FIG. 1, the reliefs 341 may in themselves form elements for massaging an area of the body.

According to another embodiment the first face 340 may support application means such as a pad, sponge, or cushion. Such application means may be formed of an open-cell or a closed-cell foam. In one example, the application means are covered with a textile. Other examples cover the application means with flexible bristles, with rigid teeth, with exfoliating means such as an abrasive coating, or alternatively with natural or synthetic fibers (woven, non-woven, wadding). The previous list provides specific examples, but other materials may be used.

In example shown in FIG. 1, the reliefs 341 define channels which can receive adhesive means, such as adhesive, designed to attach the application means. In this particular example, these channels are concentric. However, other means of attaching the application means may be implemented.

In the example shown in FIG. 3, a mount 35 extends outward from the second face 342. This mount comprises an annulus 350, a platform 351 and a sleeve 352. Each constituent part of this mount may be concentric with the sleeve tube 30 of the member 3. In the example shown in FIG. 3, the mount has a tiered overall configuration. The annulus 350 rises out from the second face 342. The platform 351 extends radially from the annulus 350. The sleeve 352 extends from the platform 351. As shown in FIG. 3, the sleeve 352 may have a frustoconical overall configuration. The sleeve 352 typically has a free edge 353.

The platform 351 may have the overall configuration of a disc or washer with a central opening in it. This disc may have an external edge through which a passage 354 passes.

As can be seen in FIGS. 4, 6, and 7, the passage 354 may comprise a slot. This slot may extend through the thickness of the platform 351 and of the sleeve 352. This slot may be arranged in the form of a bore with a cross section of a shape that complements that of the tab 122. Such a cross section may for example be U-shaped or V-shaped. As an alternative, the passage 354 may comprise a flat (not depicted). A flat such as this may equally be provided at the mount 35 and, in particular, at the platform 351 and at the sleeve 352.

As far as this massage and/or dispensing member 3 is concerned, when projected onto a plane of projection orthogonal to the axis of rotation Y, the sleeve tube 30, particularly the part 31 for mounting to the body 2, and the mount 35, which collaborates with the tab (restriction means) 121 of part 1, may fall entirely inside the portion forming or supporting the application element 34 of the massage and/or application surface. The sleeve tube, the mount and the portion forming or supporting the application element may be produced as a single, integral component.

An example of a way in which a massage and/or dispensing head, according to one embodiment of the invention, is mounted will now be described. The axle 4 supporting the body 2 may be mounted in the housing 102 of the first part of the outer casing. Next, the second part 11 of the outer casing may be coupled with the first part 10 of the outer casing. This assembly closes off the lateral notch on a free edge 100 in the first part 10 of the outer casing. The sleeve 114 is mounted around the support piece 22 of the body 2. This sleeve 114 may press against the ring 21. The support piece 22 then extends through the opening defined by the free edging 115 of the sleeve 114. In other words, the support piece 22 projects into the bowl 111. The body 2 is then mounted for rotation on the axle 4 about an axis of rotation Y.

When the second part 11 of the outer casing is assembled with the first part 10, the external periphery 118 of the second part typically comes into attaching engagement with the free edge 100 of the first part 10. More specifically, the rib 101 becomes lodged in the groove 119. The external periphery 118 and the projection 120 then extend in engagement, clamping the rib 101 from each side. This method of attachment is not limiting, and it is possible for other means of attachment to be implemented.

Member 3 is preferably configured to be mounted removably in the fixed outer casing 1. Member 3 is typically introduced into the bowl 111 in such a way as to be associated with, i.e., coupled to, the body 2.

To guide the mounting of the member 3 on the body 2, the axle 4 may extend into the channel of the body 2 beyond the orifice 224. This axle 4 may be of a length such that when the member 3 is in the mounted position, it can extend as far as the outlet orifice 330 of the duct 33 as shown in FIG. 8. The axle 4 can therefore act as a means for guiding the positioning of the member 3 on the body 2. The curved or tapered end of the axle 4 assists in guiding the member 3 into the body 2. During this mounting, the free edge 353 of the mount 35 can bear against the chamfer 122 of the tab 121. As can be seen in FIG. 2, this bearing causes the tab 121 to be moved outwards. The member 3, and particularly the sleeve 352, can then be moved while sliding or rubbing against the tab 121. Once negotiated past the sleeve 352, the tab 121 can return, to at least some extent, to its initial configuration as shown in FIG. 3.

The member 3 is preferably positioned around the support piece 22 of the body 2. More specifically, the mounting part 31 of the member 3 is preferably mounted as a tight fit around this support piece 22. In other words, the support piece 22 may be securely push-fitted or press-fitted into the mounting part 31. The internal step 32 of the member 3 can limit the extent to which the body 2 can be push-fitted axially into the member 3. It should be noted that the arrangement described can very well be reversed such that the support piece 22 of the body 2 is securely engaged around the mounting part 31 of the member 3.

The ribs 312 of the mounting part 31 can improve the grip between the support piece 22 and the mounting part 31. Furthermore, the fact that the external face of the support piece 22 and the internal face of the mounting part have cross sections of non-circular shape prevents the member 3 from rotating relative to the body 2.

It should be noted that the deformable and/or movable nature of the tab 121 is particularly advantageous because it allows the member 3 and the body 2 to be coupled to each other independently of the positioning of this tab 121. In addition, this mounting can typically be done independently of the orientation of the support piece 22 with respect to the mounting part 31.

The free edge 314 of the mounting part 31 of the sleeve can butt against the free edge 115 of the sleeve 114. Likewise, the transverse wall 223 of the support piece 22 can butt against the internal step 32 of the sleeve tube 30. The orifice 224 of the channel then faces the opening 320 of the duct. When the axle 4 extends into the body 2, the member 3 is in direct fluidic communication with the body 2.

The free edge 353 of the mount 35, in one example, bears against the external step 112 as shown in FIG. 3.

Advantageously, the member 3 at least partially projects from the bib 110 of the second part 11 of the outer casing 1. More specifically, the application element 34 projects through the opening defined by the free edging 116 of the bowl 111 as shown in FIG. 3.

Once the member 3 has been mounted on the body 2, it can typically be rotated, by the body 2, about the axis of rotation Y. In one example, this rotation is continuous. The member 3 rotates with respect to the outer casing 1, which remains stationary. In a preferred embodiment, the axle 4 forms a fixed piece about which the body 2 and the member 3 rotate as one.

The outer casing 1 typically defines a guide rail for the rotational movement of the member 3. This guide rail may comprise a top stop and a bottom stop. In particular, the external step 112 may form a bottom stop for the sleeve 352 and the tab 121 may form a top stop for the platform 351. The wall section 117 of the bowl 111 may guide the rotation of the sleeve 352 of the member 3.

The tab 121 is able to restrict the translational movement of the member 3 along the axis of rotation Y. This being the case, the tab 121 and the slot 354 typically do not face one another. The tab 121 and the slot 354 extend in two different planes, P1 and P2 respectively, which are secant to each other as shown in FIG. 4. The tab 121 may have a substantially flat, chamfer-less face facing the platform 351 so that the member 3 cannot become detached from the outer casing 1. If the user attempts to detach the member 3 from the outer casing 1 then the platform 351 comes into abutment against the tab 121. This arrangement therefore prevents unwanted removal of the member 3 relative to the outer casing 1.

The massage or application surface of the member 3 in the position, in which the member is mounted on the body 2, may in general run obliquely or at a right angle to the axis of rotation Y. More specifically, this surface may define a plane of contact with an area of skin which runs obliquely or at right angles to the axis of rotation. In other words, this surface is neither coincident nor parallel with the axis of rotation. When this massage surface comprises one or more reliefs 341, this plane may be defined by all or some of the free ends of the reliefs 341. When the reliefs comprise one or more domed or convex portions, such a plane may be defined by a tangent to one or more vertices of these portions.

It should also be noted that the part of the body 2 for mounting the member 3, namely the support piece 22, and the tab (restriction means) 121 of the outer casing may both be exclusively provided on one and the same side of the application element 34. In particular, the mounting part and the restriction means may extend on a side of the application element which is the opposite side to the massage and/or application surface 341. Thus, on the one hand, the massage and/or application surface configured to come into contact with the area of skin may be entirely accessible to a user and, on the other hand, the way in which the massage member is attached is at least somewhat hidden from view.

According to one example of the invention, in order to detach the member 3 from the outer casing 1, the member 3 is moved through two distinct movements, including a rotational movement and a translational movement.

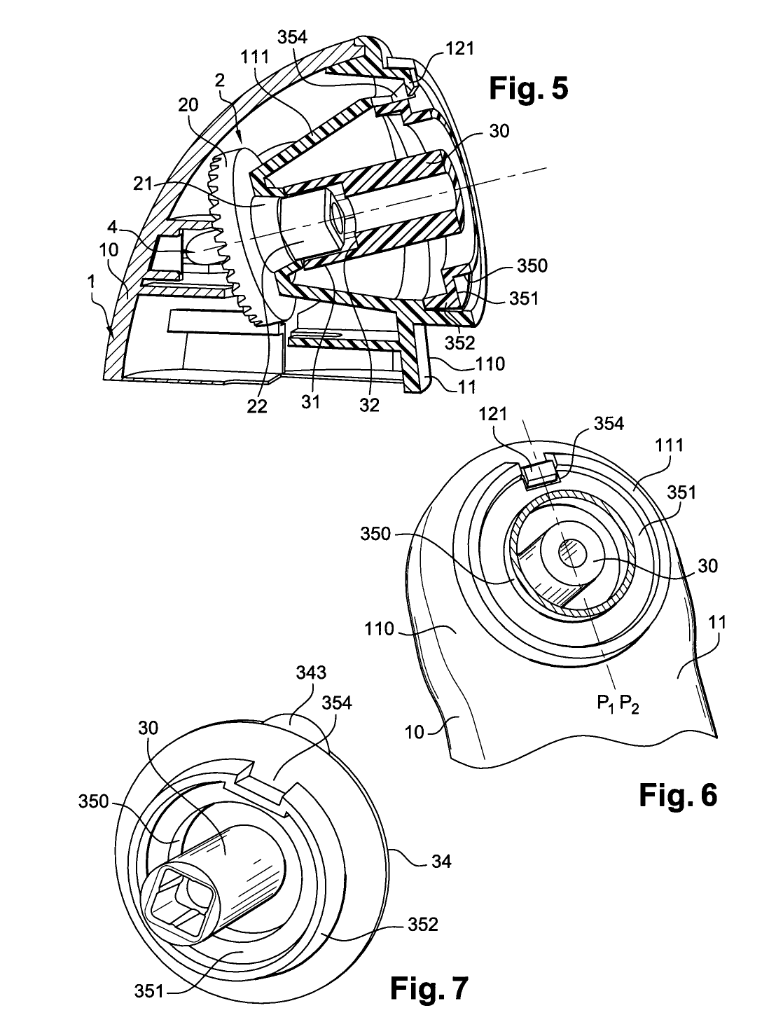

As can be seen in the examples shown in FIGS. 5 and 6, the member 3 may be moved rotationally to position the slot 354 facing the tab 121. In other words, the member 3 is moved rotationally until the planes P1 and P2 coincide. Once the member 3 has been angularly positioned relative to the outer casing 1, the user can perform translational movement of the member 3 in an axial direction to remove the member 3 from the body 2 and outer casing 1. To do this, the user typically takes hold of the application element 34 and pulls on the member 3 to separate it from the body 2 and fully remove or extract it from the outer casing 1. The slot 354 guides this translational movement of the member 3. The slot 354 can thus be can be considered a passage through which the restriction means can be moved.

When the member 3 is in the mounted position, the user will preferably no longer be able to see the slot 354, or at least a portion of the slot 354 will be hidden. It may therefore prove somewhat tricky to position the slot 354 and the tab 121 in alignment with each other. Thus, as can be seen in FIG. 7, the massage and/or dispensing head may comprise one or more markings or indexing projections 343 as a means of marking. The markings allow the user to determine the angle of rotation that needs to be imparted to the member 3 before it can be moved translationally. These markings 343 preferably extend in the plane P2 of the slot 354. Such markings 343 thus indicate the location of the slot on the member 3. In one example, the markings 343 include a tag extending from an external edge of the application element 34. Preferably, all the user then has to do is to position the tag facing the tab 121 in order to have positioned the slot 354 facing this tab 121. The user then knows that the member 3 can be moved translationally in order to extract it from the outer casing 1.

In the example shown in FIG. 1, the ribs 312 of the mounting part 31 reduce the area of contact between the member 3 and the body 2, thus reducing friction and making it easier to remove the member 3, particularly in the direction of translation.

FIGS. 8 and 9 depict a massage and/or dispensing device according to one example of the invention comprising a massage and/or dispensing head on top of container 5. The outer casing 1 is then associated with this container by any appropriate means, such as clip-fastening or threading.

The container 5 may contain a liquid or pasty product, such as a cosmetic product. This container may have any appropriate shape. In the example depicted in FIGS. 8 and 9, this container has a side wall 50 in the overall shape of a cylinder of revolution. This container extends along a longitudinal axis X. In one example, the container used is an aerosol container. Thus, in addition to the cosmetic product, the container may also contain a propellent gas.

A container such as the one depicted in FIGS. 8 and 9 may be provided with a dispensing valve 6 able to initiate release of product from the container 5. This valve comprises a valve stem, which preferably extends along the axis of the container X or at least in an axial direction of the container 5. The valve stem is typically actuated by an actuating member 60. The actuating member may be separate from the outer casing and preferably extends on the outside of this casing so as to be readily accessible to the user. The actuating member 60 can be moved in order to rock the valve stem, preferably along an axis perpendicular to the axis of the valve stem.

In the example shown in FIG. 8, the actuating member 60 comprises a skirt 61 mounted on the valve stem. In one embodiment, the skirt 61 is push-fitted onto the valve stem.

A dispensing tube 62, in one example, a flexible one, connects the valve stem to the massage and/or dispensing member 3. This tube 62 may, on the one hand, be push-fitted onto the skirt 61 and, on the other hand, be fixed into the aperture formed through the axle 4. Thus, the product leaving the valve stem can be propelled through the skirt 61 and guided along the tube 62, the axle 4, the channel in the body 2, and then through the duct in the member 3. In this example, the product is then finally expelled through the outlet orifice 330. The second face 342 or an application means that it supports may then become impregnated with the expelled product.

In one embodiment, the axle 4 extends into the channel of the body 2 or even into the duct of the member 3 as far as the outlet orifice. Thus, in this embodiment, the product is prevented from coming into direct contact with the channel and with the duct. In this case, the axle 4 may alone form a product dispensing passageway as shown in FIG. 8. This arrangement reduces sealing problems that might arise associated with assembling the member 3 on the body 2.

In the example depicted in FIG. 8, the outer casing 11 houses a system for rotating the member 3. The rotation system typically operates independently of the product dispensing system. A system such as this may comprise a motor 7 connected to a source of power 8, such as a battery, controlled by a control member 9. The motor 7 preferably rotates the member 3 through a transmission system 23, which typically includes gears.

The source of power 8 may comprise a battery formed of one or more cells. Alternatively, the motor 7 may be mains powered, e.g., from a household wall socket.

The control member 9 allows the user selectively to switch the power supply to the motor 7 on or off. This control member 9 also preferably makes it possible to select various rotational speeds for the motor 7. One example of the control member 9 is an electrical switch equipped with a rotary selector protruding beyond the outer casing so that it can, for example, be positioned in different positions such as a first, off, position, a second position corresponding to a first rotational speed, and a third position corresponding to a second rotational speed. The control member 9 may in particular comprise a variator for continuously varying the rotational speed of the motor 7 in order to achieve more fine adjustment of the massage effect desired, particularly depending on the massage member 3 fitted and which area of skin is being massaged.

The transmission system 23, may include a number of gear wheels and collaborate with the crown gear 20 of the body 2 so as to rotate it. In this example, rotation of the body 2 is transmitted to the member 3. The transmission system 23 forms a means of reducing the rotational speed of the massage member in order to allow the torque to be increased.

It should be noted that the axis of rotation Y can extend along an axis distinct from the longitudinal axis X of the container. In particular, this axis Y may extend obliquely or at a right angle to the longitudinal axis X. For example, the axis X and the axis Y may together define an angle α, it being possible for the angle to be in the range from 90° to 180°, inclusive, and preferably from 100 and 140°, inclusive, and more preferably, between 105° and 120° inclusive.

Throughout the description, the expressions “comprising a,” “including a,” “including one,” and “having a,” should be considered to be synonymous with “comprising at least one” unless specified otherwise.

Numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A head for applying a product, comprising:
a removable member;
a body that rotates the removable member about an axis of rotation, the removable member being removably coupled to the body; and
a part including a movement restriction means for restricting movement of the removable member along the axis of rotation, the rotation of the removable member being relative to this part,
wherein the removable member is configured to be secured to the part independently of its orientation relative to the restriction tab and to be detached from the part by being moved through two movements including a rotational movement and a translational movement.

2. The head according to claim 1, further comprising means for preventing the removable member from rotating relative to the body.

3. The head according to claim 2, wherein the removable member comprises an internal face comprising at least one rib.

4. The head according to claim 2, wherein the body and the removable member include first and second mutual-assembly parts, respectively, the first and second mutual-assembly parts have a non-circular cross section, and the mutual assembly parts fit together.

5. The head according to claim 4, wherein the mutual-assembly parts each have a cross section of complementary polygonal shape.

6. The head according to claim 5, wherein the shape is square.

7. The head according to claim 1, wherein the part comprises an outer casing configured to at least partially envelop the body and the removable member.

8. The head according to claim 1, wherein the removable member has at least one relief.

9. The head according to claim 1, wherein the body and the restriction means are both provided on a same side of an element supporting an application surface.

10. The head according to claim 9, wherein the body and the restriction means are both provided on a side opposite the application surface.

11. The head according to claim 1, wherein the restriction means move radially outward as the member is mounted on the body.

12. The head according to claim 1, wherein the restriction means are configured to pivot relative to the part.

13. The head according to claim 1, wherein the restriction means are elastically deformable.

14. The head according to claim 1, wherein the restriction means and the part are a single, integral piece.

15. The head according to claim 1, wherein the part includes a free edge defining an opening through which the removable member extends, the restriction means comprising a tab projecting into the opening.

16. The head according to claim 1, wherein the removable member includes a passage configured to be positioned facing the restriction means.

17. The head according to claim 16, wherein the passage includes a slot disposed on a periphery of the removable member.

18. The head according to claim 17, wherein the slot is disposed on an external edge of the removable member.

19. The head according to claim 1, wherein the restriction means include a chamfer.

20. The head according to claim 1, wherein the removable member includes marking means for indicating a position of the removable member relative to the part as the removable member is being removed.

21. The head according to claim 1, wherein the part defines a guide rail that guides rotational movement of the removable member.

22. The head according to claim 21, wherein the guide rail is disposed around a circumference of the part.

23. The head according to claim 1, wherein the removable member includes a duct open to an outlet orifice.

24. The head according to claim 23, wherein the body includes a channel facing the duct.

25. The head according to claim 1, further comprising a motor connected to a source of power controlled by a control member, the motor connected to drive the removable member through a transmission system including at least one gear.

26. The head according claim 1, wherein the body is push-fitted into the removable member.

27. The head according to claim 1, wherein the removable member comprises an internal step limiting the extent to which the body can be push-fitted into the removable member.

28. The head according to claim 1, wherein the member comprises an application surface directed obliquely or at a right angle to the axis of rotation.

29. The head according to claim 1, wherein the body includes gear teeth.

30. A dispensing device comprising:
a container configured to hold a product,
wherein the container is connected to the head according to claim 1.

31. The device according to claim 30, wherein the container extends along a longitudinal axis, the removable member is rotated about an axis of rotation, the axis of rotation defines an angle with the longitudinal axis of the container, the angle being from 90 to 180°, inclusive.

32. The device according to claim 30, wherein the removable member rotates continuously in a circle.

33. A head for applying a product, comprising:
a removable member;
a body that rotates the removable member about an axis of rotation, the removable member being removably coupled to the body; and
a part including a movement restriction tab that restricts movement of the removable member along the axis of rotation, the rotation of the removable member being relative to this part,
wherein the removable member is configured to be secured to the part independently of its orientation relative to the restriction tab and to be detached from the part by being moved through two movements including a rotational movement and a translational movement.
